(19) United States
(12) Patent Application Publication
(10) Pub. No.: US 2007/0234725 A1
(43) Pub. Date: Oct. 11, 2007

(54) Counterbalanced fuel slinger in a gas turbine engine

(75) Inventors: Ian L. Critchley, Phoenix, AZ (US); James L. Hadder, Scottsdale, AZ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/393,580

(22) Filed: Mar. 29, 2006

(51) Int. Cl. F02C 7/22

(52) U.S. Cl. 60/744

(57) ABSTRACT

A rotary fuel slinger and a turbine engine including the rotary fuel source is provided. The rotary fuel slinger includes a coupler shaft coupled to a turbine shaft of the turbine engine and is configured to rotate therewith. The slinger further includes a slinger disc coupled to the coupler shaft and configured to rotate therewith. The slinger disc includes a vertical shoulder extending substantially perpendicular to the coupler shaft and a slinger disc rim extending substantially perpendicularly from the vertical shoulder. The slinger disc rim is configured to define a cup-shaped section and a counterbalance mass, wherein the cup-shaped section is counterbalanced by the counterbalance mass. The rotary fuel slinger is adapted to receive a rotational drive force and to receive a flow of fuel from a fuel source and configured, upon receipt of the rotational drive force, to centrifuge the received fuel into a combustion chamber of the turbine engine.

### TECHNICAL FIELD

The present invention relates to a gas turbine engine and, more particularly, to a fuel injection system including a counterbalanced fuel slinger for use in a high speed gas turbine engine.

### BACKGROUND

In many aircraft, the main propulsion engines not only provide propulsion for the aircraft, but may also be used to drive various other rotating components such as, for example, generators, compressors, and pumps, which supply electrical and/or pneumatic power to the aircraft. However, when an aircraft is on the ground, its main engines may not be operating. Moreover, in some instances the main propulsion engines may not be capable of supplying the power needed for propulsion as well as the power to drive these other rotating components. Thus, many aircraft include one or more turbine engines, such as an auxiliary power unit (APU), to supplement the main propulsion engines in providing electrical and/or pneumatic power. These additional turbine engines may also be used to start the propulsion engines.

A gas turbine engine typically includes a combustion system, a power turbine, and a compressor. During operation of the turbine engine, the compressor draws in ambient air, compresses it, and supplies compressed air to the combustion system. The combustion system receives fuel from a fuel source and the compressed air from the compressor, and supplies high-energy combusted air to the power turbine, causing it to rotate. The power turbine includes a shaft that may be used to drive a external load compressor.

In some instances the engine may need to be started under cold soaked conditions at high altitudes with relatively low engine cranking speeds. The combustion system may be implemented with a slinger atomization system that comprises an annular combustor that receives fuel fed through holes or ports in a rotating shaft connecting the compressor and turbine. More particularly, the slinger atomization system includes a rotary slinger combustor that uses a rotary fuel slinger or slinger disc to inject a continuous sheet of fuel into the annular combustor. Conventional slinger disc rims have a cup shaped cross-section and holes or ports in the rim through which the fuel flows. The cup serves to catch fuel and distribute it around the circumference of the disc improving spray uniformity; the holes aid the atomization process.

Although this type of slinger atomization system is generally safe and reliable, it can suffer certain drawbacks. For example, the low cranking speed, combined with cold, viscous fuel during a start under cold soaked conditions can degrade the atomization quality of the fuel spray to the point where ignition may not be possible. This can be countered by designing a slinger disc with a larger diameter; however this results in very high disc rim speeds when the engine is running at full speed. Typical slinger atomization systems run with a maximum disc rim speed below ˜800 ft/s. A slinger disc that runs at very high rim speeds may have unacceptably high stresses in the rim, generally in the region of the fuel ports. At high rim speeds the cup will tend to bend outwards resulting in high stresses near the base of the cup in the region of the fuel holes. These high stresses limit the maximum rim speed for which the slinger disc can be designed and the ability of a turbine engine to start at high altitude.

Hence, there is a need for a combustion system that includes a rotary slinger combustor, and more particularly a slinger disc that is designed to operate at high rim speeds without additional stresses occurring to the slinger disc. The present invention addresses this need.

### BRIEF SUMMARY

The present invention provides a rotary fuel slinger for implementation into a turbine engine. The slinger includes a coupler shaft coupled to a turbine shaft of the turbine engine and configured to rotate therewith. The slinger further includes a slinger disc coupled to the coupler shaft and configured to rotate therewith. The slinger disc includes a vertical shoulder extending substantially perpendicular to the coupler shaft and a slinger disc rim extending substantially perpendicularly from the vertical shoulder. The slinger disc rim is configured to define a cup-shaped section and a counterbalance mass, wherein the cup-shaped section is counterbalanced by the counterbalance mass. The rotary fuel slinger is adapted to receive a rotational drive force and to receive a flow of fuel from a fuel source. Upon receipt of the rotational drive force, the received fuel is centrifuged into a combustion chamber of the turbine engine.

In another embodiment, and by way of example only, a turbine engine including the rotary fuel slinger is provided. A turbine engine is provided including a compressor coupled to the turbine output shaft and having an air inlet and a compressed air outlet. The engine further includes a combustor in fluidic communication with the compressed air outlet and a turbine having an output shaft, the turbine in fluid communication with at least a portion of the combustor. A rotary fuel slinger is provided in the engine including a coupler shaft coupled to the output shaft of the turbine and adapted to receive a rotational drive force. The rotary fuel slinger is further configured to include a slinger disc coupled to the coupler shaft. The slinger disc includes a vertical shoulder and a slinger disc rim. The slinger disc rim is configured to define a cup-shaped section and a counterbalance mass, wherein the cup-shaped section is counterbalanced by the counterbalance mass. The rotary fuel slinger is further adapted to receive a flow of fuel from a fuel source and configured, upon receipt of the rotational drive force, to centrifuge the received fuel into the combustor. The engine further includes an igniter operable to ignite the fuel and compressed air in the combustor and thereby generate combusted gas and a turbine coupled to receive the combusted gas from the combustion chamber and in response thereto, supply at least the rotational drive force to the rotary fuel slinger.

Other independent features and advantages of the preferred system will become apparent from the following detailed description, taken in conjunction with the accompanying drawings which illustrate, by way of example, the principles of the invention.

### BRIEF DESCRIPTION OF THE DRAWINGS

FIG. 1 is a cross section view of a portion of an auxiliary power unit according to an exemplary embodiment of the present invention;

FIG. 2 is a close up simplified cross section view of a portion of an exemplary combustion system that is used in the auxiliary power unit of FIG. 1; and

FIG. 3 is a close up simplified cross section view of a rotary fuel slinger to combustor interface that is implemented into the combustor system shown in FIG. 2.

### DETAILED DESCRIPTION OF A PREFERRED EMBODIMENT

Before proceeding with a detailed description, it is to be appreciated that the described embodiment is not limited to use in conjunction with a particular type of turbine engine. Thus, although the present embodiment is, for convenience of explanation, depicted and described as being implemented as an auxiliary power unit, it will be appreciated that it can be implemented as various other types of devices, and in various other systems and environments.

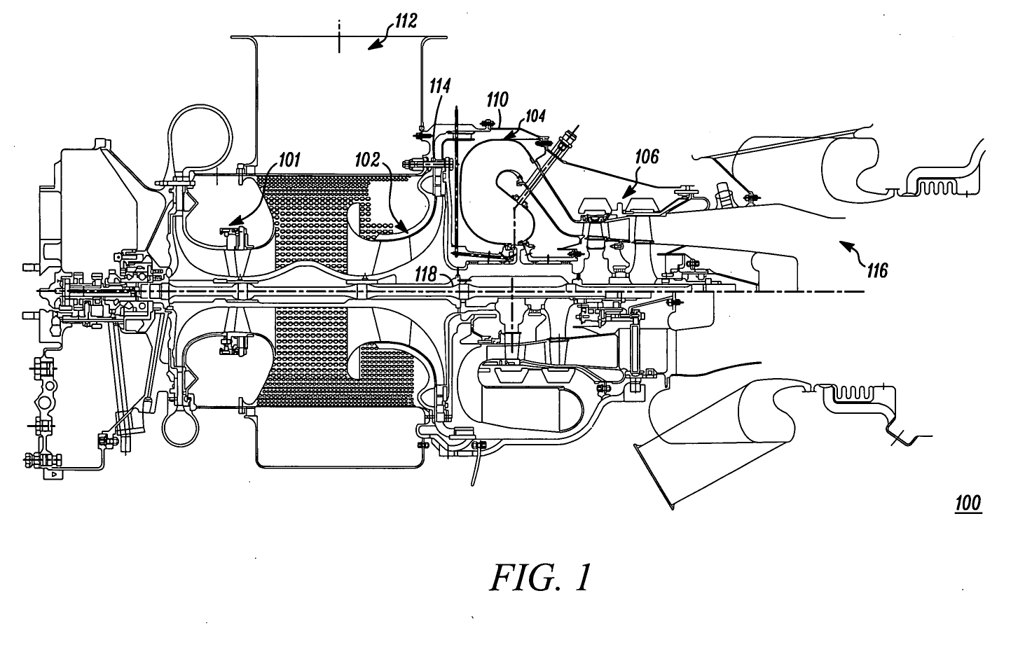

Turning now to the description and with reference to FIG. 1, a cross section view of a portion of an exemplary assembled auxiliary power unit (APU) is shown. The APU 100 includes a load compressor 101, an engine compressor 102, a combustion system 104, and a turbine 106, all disposed within a case 110. Air is directed into the load compressor 101 and the engine compressor 102 via an air inlet 112. The load compressor 101 and engine compressor 102 raise the pressure of air and compressor 102 supplies compressed air via a diffuser 114. In the depicted embodiment, the load compressor 101 and the engine compressor 102 are high-pressure ratio centrifugal compressors. However, it will be appreciated that this is merely exemplary of a preferred embodiment, and that other types of compressors could also be used.

The compressed air from the engine compressor 102 is directed into the combustion system 104, where it is mixed with fuel supplied from a fuel source (not shown). In the combustion system 104 the fuel/air mixture is combusted, generating high-energy gas. The high-energy gas is then diluted and supplied to the turbine 106. A more detailed description of the combustion system 104, and the various components that provide this functionality, is provided further below.

The high-energy, diluted gas from the combustion system 104 expands through the turbine 106, where it gives up much of its energy and causes the turbine 106 to rotate. The gas is then exhausted from the APU 100 via an exhaust gas outlet 116. As the turbine 106 rotates, it drives, via a turbine shaft 118, various types of equipment that may be mounted in, or coupled to, the engine 100. For example, in the depicted embodiment the turbine 106 drives the compressors 101 and 102. It will be appreciated that the turbine may also be used to drive a generator and/or other rotational equipment.

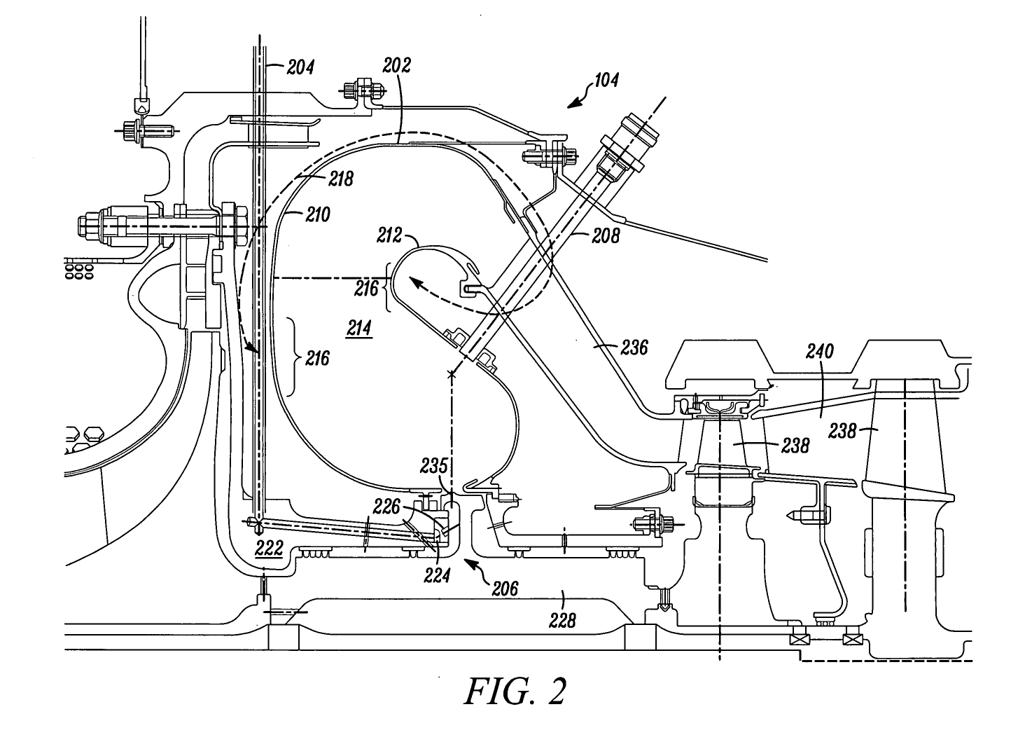

Turning now to FIG. 2, a close up simplified cross section view of the assembled combustion system 104 is illustrated. The combustion system 104 includes a combustor 202, a fuel supply tube 204, a rotary fuel slinger 206, and an igniter 208. The combustor 202 is a radial-annular combustor, and includes a forward annular liner 210, and an aft annular liner 212. The forward and aft annular liners 210, 212 are spaced apart from one another and form a combustion chamber 214. The forward and aft annular liners 210, 212 each include a plurality of air inlet orifices 216 (only some of which are shown), and a plurality of effusion cooling holes (not illustrated). As illustrated via the flow arrows in FIG. 2, compressed air 218 from the compressor 102 flows into the combustion chamber 214 via the air inlet orifices 216 in both the forward and aft annular liners 210, 212.

The fuel supply tube 204, which is preferably a steel tube, connects to a connecting passage 222 just forward of the combustor 202 and is adapted to receive a flow of fuel from a non-illustrated fuel source. It should be understood that the fuel supply tube 204 need not necessarily be routed forward of the combustor and in an alternative embodiment, the fuel supply tube 204 could be routed through a turbine inlet nozzle (described presently). The fuel supply tube 204 is preferably attached to the connecting passage 222, and is preferably configured with sufficient flexibility, to allow for any thermal mismatches that may occur between other components and systems in the APU 100 during operation. The fuel supplied to the fuel supply tube 204 passes through the tube 204, the connecting passage 222, and is directed into a fuel housing 224. In the depicted embodiment, the fuel housing 224 is configured as a circumferential cavity, though it will be appreciated that other configurations could also be used. The fuel housing 224 includes a plurality of equally spaced holes 226 (only one of which is shown), through which the fuel is jetted to the rotary fuel slinger 206. In the depicted embodiment, the slinger 206 includes a plurality of relatively small, spaced fuel holes or slots 235. As the slinger 206 rotates, fuel is centrifuged through these holes 235, as it exits the holes 235 the fuel is atomized into tiny droplets and is evenly distributed into the combustion chamber 214. The evenly distributed fuel droplets are readily evaporated and ignited in the combustion chamber 214.

The igniter 208 extends through the aft annular liner 212 and partially into the combustion chamber 214. The igniter 208, which may be any one of numerous types of igniters, is adapted to receive energy from an exciter (not shown) in response to the exciter receiving an ignition command from an external source, such as an engine controller (not illustrated). In response to the ignition command, the igniter 208 generates a spark of suitable energy, which ignites the fuel-air mixture in the combustion chamber 214, and generates the high-energy combusted gas that is supplied to the turbine 106.

The high-energy combusted gas is supplied from the combustor 202 to the turbine 106 via a turbine inlet nozzle 236 which then directs the air to a turbine. In this embodiment, the turbine is a two stage turbine and includes two sets of turbine rotors 238 disposed on either side of a second turbine nozzle 240. As the high-energy combusted air passes through the nozzles 236, 240 and impinges on the rotors 238, the rotors 238 rotate, which in turn causes the turbine shaft 118 to rotate, which in turn rotates the various other equipment that is coupled to the turbine shaft 118.

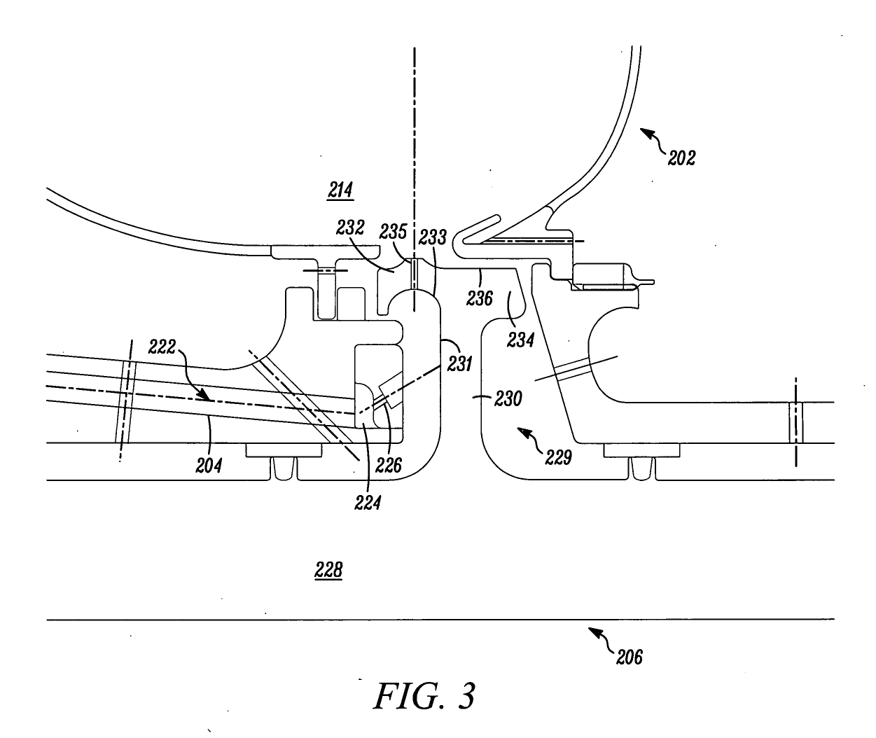

Turning now to FIG. 3, a close up cross section view of the rotary fuel slinger 206 to combustor 202 interface is illustrated. The rotary fuel slinger 206 includes a coupler shaft 228 and a slinger disc 229. Slinger disc 229 includes a vertical shoulder 230, and a slinger disc rim 232. The coupler shaft 228 is coupled to the turbine shaft 118 (shown in FIG. 1) and rotates therewith. The slinger disc 229 and more particularly the vertical shoulder 230 is coupled to, and is preferably formed as an integral part of, the coupler shaft 228 and thus rotates with the coupler shaft 228. The fuel that is jetted through the holes 226 in the fuel housing 224 impinges onto a sidewall 231 of the vertical shoulder 230. Because the slinger disc 229 rotates with the coupler shaft 228, the impinging fuel acquires the tangential velocity of the coupler shaft 228 and gets centrifuged into the slinger disc rim 232.

The slinger disc rim 232 is coupled to, and is preferably formed as an integral part of, the vertical shoulder 230 and thus also rotates with the coupler shaft 228. In the depicted embodiment, the slinger disc rim 232 has a cup-shaped section 233 that is counterbalanced by a counterbalance mass 234. Counterbalance mass 234 can be configured to aid the flow of purge air over a rim 236 of the slinger disc rim 232. Slinger disc rim 232 further includes the plurality of relatively small, equally spaced fuel holes or slots 235. As the slinger disc rim 232 rotates, fuel is centrifuged through these holes 235, atomized into tiny droplets upon exiting holes 235 and evenly distributed into the combustion chamber 214. The evenly distributed fuel droplets are readily evaporated and ignited in the combustion chamber 214.

During operation of rotary fuel slinger 206 counterbalance mass 234 serves to counteract the tendency of cup-shaped section 233 to bend outwards by effectively counterbalancing the cup-shaped section 233 with a substantially equivalent mass on the opposite side of the slinger disc rim 232. At any given rim speed the stresses in the region of the fuel hole 235 can be reduced. This counterbalancing allows the slinger disc rim 232 to be designed for higher rim speeds, thereby improving the ability of the turbine engine to start at cold, high altitude conditions.

There has now been provided a combustion system that includes a rotary slinger combustor that is relatively simple to install. The system also includes fewer components than previous-known combustion systems. Moreover, the system is relatively inexpensive to fabricate and may be retrofitted into existing engines.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

We claim:

1. A rotary fuel slinger in a turbine engine, the slinger comprising:
a coupler shaft coupled to a turbine shaft of the turbine engine and configured to rotate therewith; and
a slinger disc coupled to the coupler shaft and configured to rotate therewith, the slinger disc including a vertical shoulder extending substantially perpendicular to the coupler shaft and a slinger disc rim extending substantially perpendicularly from the vertical shoulder, the slinger disc rim configured to define a cup-shaped section and a counterbalance mass, wherein the cup-shaped section is counterbalanced by the counterbalance mass;
wherein the rotary fuel slinger is adapted to receive a rotational drive force, the rotary fuel slinger further adapted to receive a flow of fuel from a fuel source and configured, upon receipt of the rotational drive force, to centrifuge the received fuel into a combustion chamber of the turbine engine.

2. The rotary fuel slinger of claim 1, wherein the coupler shaft and the slinger disc are integrally formed.

3. The rotary fuel slinger of claim 1, wherein the slinger disc rim includes a plurality of evenly spaced annular openings extending therethrough.

4. The rotary fuel slinger of claim 3, wherein the fuel supplied to the rotary fuel slinger impinges on the vertical shoulder and is centrifuged into the cup-shaped section of the slinger disc rim.

5. The rotary fuel slinger of claim 1, wherein the counterbalance mass is adapted to counteract the outward flexion of the cup-shaped section by counterbalancing the cup-shaped section with a substantially equivalent mass.

6. A turbine engine comprising:
a compressor coupled to the turbine output shaft and having an air inlet and a compressed air outlet;
a combustor in fluidic communication with the compressed air outlet;
a turbine having an output shaft, the turbine in fluid communication with at least a portion of the combustor;
a rotary fuel slinger the rotary fuel slinger including a coupler shaft coupled to the output shaft of the turbine and adapted to receive a rotational drive force, the rotary fuel slinger further configured to include a slinger disc coupled to the coupler shaft, the slinger disc including a vertical shoulder and a slinger disc rim, the slinger disc rim configured to define a cup-shaped section and a counterbalance mass, wherein the cup-shaped section is counterbalanced by the counterbalance mass, the rotary fuel slinger further adapted to receive a flow of fuel from a fuel source and configured, upon receipt of the rotational drive force, to centrifuge the received fuel into the combustor;
an igniter operable to ignite the fuel and compressed air in the combustor and thereby generate combusted gas;
a turbine coupled to receive the combusted gas from the combustion chamber and in response thereto, supply at least the rotational drive force to the rotary fuel slinger.

7. The turbine engine of claim 6, wherein the combustor is a radially-annular combustor and includes at least a forward radial liner and an aft radial liner spaced apart from one another to form a combustion chamber there between, the forward and aft radial liners each including a plurality of openings in fluid communication with the compressed air outlet, to thereby receive at least a portion of the flow of compressed air therefrom, the plurality of openings configured to generate a single toroidal recirculation air flow pattern in the combustion chamber

8. The turbine engine of claim 6, wherein the coupler shaft and the slinger disc are integrally formed.

9. The turbine engine of claim 6, wherein the slinger disc rim includes a plurality of evenly spaced annular fuel openings extending therethrough.

10. The turbine engine of claim 9, wherein the annular fuel openings are aligned with an annular gap formed between the forward annular liner and the aft annular liner.

11. The turbine engine of claim 6, wherein the fuel supplied to the rotary fuel slinger impinges on the vertical shoulder and is centrifuged into the cup-shaped section of the slinger disc rim.

12. The turbine engine of claim 6, wherein the counterbalance mass is adapted to counteract the outward flexion of the cup-shaped section by counterbalancing the cup-shaped section with a substantially equivalent mass.

13. The turbine engine of claim 6, wherein the igniter extends through the aft radial liner and at least partially into the combustion chamber, the igniter adapted to receive an ignition command and operable, in response thereto.

14. The turbine engine of claim 6, further including a turbine inlet nozzle disposed between the radial combustor and the turbine inlet, the turbine nozzle configured to change a flow direction of the combusted gas from a radial flow direction to an axial flow direction.

15. A turbine engine comprising:
a compressor having an air inlet and a compressed air outlet, and operable to supply a flow of compressed air;
a radial-annular combustor including at least a forward radial liner and an aft radial liner spaced apart from one another to form a combustion chamber therebetween, the forward and aft radial liners each including a plurality of openings in fluid communication with the compressed air outlet, to thereby receive at least a portion of the flow of compressed air therefrom, the plurality of openings configured to generate a single toroidal recirculation air flow pattern in the combustion chamber;
a rotary fuel slinger including a coupler shaft and a slinger disc integrally formed with the coupler shaft and configured to rotate therewith, the slinger disc including a vertical shoulder and a slinger disc rim configured to define a cup-shaped section and a counterbalance mass, wherein the cup-shaped section is counterbalanced by the counterbalance mass, the rotary fuel slinger adapted to receive a rotational drive force, the rotary fuel slinger further adapted to receive a flow of fuel from a fuel source and configured, upon receipt of the rotational drive force, to centrifuge the received fuel into the combustion chamber of the radial-annular combustor;
an igniter extending through the aft radial liner and at least partially into the combustion chamber, the igniter adapted to receive an ignition command and operable, in response thereto, to ignite the fuel and compressed air in the combustion chamber, to thereby generate combusted gas;
a turbine coupled to receive the combusted gas from the combustion chamber and configured, in response thereto, to supply at least the rotational drive force to the rotary fuel slinger; and
a turbine inlet nozzle disposed between the radial combustor and the turbine inlet, the turbine nozzle configured to change a flow direction of the combusted gas from a radial flow direction to an axial flow direction.

16. The turbine engine of claim 15, wherein the coupler shaft and the slinger disc are integrally formed.

17. The turbine engine of claim 15, wherein the slinger disc rim includes a plurality of evenly spaced annular fuel openings extending therethrough.

18. The turbine engine of claim 15, wherein the slinger fuel openings are aligned with an annular gap formed between the forward annular liner and the aft annular liner.

19. The turbine engine of claim 15, wherein the fuel supplied to the rotary fuel slinger impinges on the vertical shoulder and is centrifuged into the cup-shaped section of the slinger disc rim.

20. The turbine engine of claim 15, wherein the counterbalance mass is adapted to counteract the outward flexion of the cup-shaped section by counterbalancing the cup-shaped section with a substantially equivalent mass.
